(19) United States
(12) Patent Application Publication
(10) Pub. No.: US 2024/0310697 A1
(43) Pub. Date: Sep. 19, 2024

(54) AUTOFOCUS CAMERA MODULE AND MANUFACTURING METHOD THEREFOR, AND ELECTRONIC DEVICE HAVING THE AUTOFOCUS CAMERA MODULE

(71) Applicant: TRIPLE WIN TECHNOLOGY(SHENZHEN) CO.LTD., Shenzhen (CN)

(72) Inventor: TZU-LI FENG, New Taipei (TW)

(21) Appl. No.: 18/370,560

(22) Filed: Sep. 20, 2023

(30) Foreign Application Priority Data
Mar. 13, 2023 (CN) 202310265282.7

(51) Int. Cl. G03B 13/36; G02B 3/12; G02B 7/09; H04N 23/54; H04N 23/55

(52) U.S. Cl. CPC G03B 13/36; G02B 3/12; G02B 7/09; H04N 23/54; H04N 23/55

(57) ABSTRACT

An autofocus camera module includes a circuit board with a plurality of driving elements, and a lens mechanism disposed on the circuit board assembly. The lens mechanism includes a first lens assembly, a second lens assembly, and a liquid lens disposed between the first lens assembly and the second lens assembly. The first lens assembly includes a first lens holder, a first lens group housed inside the first lens holder, and a first conductive line disposed on a surface of the lens hold, the first lens holder is connected to one side of the circuit board assembly. The liquid lens includes connecting pads, and each connecting pad is disposed with a solder material, the connecting pads are soldered to the first lens holder through the solder material, the conductive line electrically connects the connecting pads and the plurality of driving elements.

### FIELD

The subject matter herein generally relates to imaging, and more particularly, to an autofocus camera module, a manufacturing method for the autofocus camera module, and an electronic device having the camera module.

### BACKGROUND

Currently, autofocus camera module may include two lens assemblies and a liquid lens between the two lens assemblies. The manufacturing method of such an autofocus camera module involves the following steps: forming a conductive line on a surface of the two lens assemblies by using Laser Direct Structuring (LDS) technology; incorporating the liquid lens between the two lens assemblies and making the liquid lens and the two lens assemblies to be aligned with each other; electrically connecting the liquid lens to the two lens assemblies through golden wires.

However, the described manufacturing steps will affect the assembly precision of the auto-focusing camera module.

### BRIEF DESCRIPTION OF THE DRAWINGS

Implementations of the present technology will now be described, by way of example only, with reference to the attached figures.

FIG. 1 is a diagrammatic view illustrating a first lens holder according to an embodiment of the present disclosure.

FIG. 2 is a diagrammatic view illustrating first conductive line formed on the first lens holder in FIG. 1.

FIG. 3 is a diagrammatic view illustrating a first lens assembly according to an embodiment of the present disclosure.

FIG. 4 is a diagrammatic view illustrating a liquid lens according to an embodiment of the present disclosure.

FIG. 5 is a diagrammatic view illustrating the liquid lens in FIG. 4 mounted to the first lens assembly in FIG. 3.

FIG. 6 is a diagrammatic view illustrating a second lens assembly mounted to the first lens assembly in FIG. 5.

FIG. 7 is a diagrammatic view illustrating a circuit board according to an embodiment of the present disclosure.

FIG. 8 is a diagrammatic view illustrating a driving element formed on the circuit board in FIG. 7.

FIG. 9 is a diagrammatic view illustrating an encapsulant formed on the driving element in FIG. 8.

FIG. 10 is a diagrammatic view illustrating the encapsulant in FIG. 8 being grounded.

FIG. 11 is a diagrammatic view illustrating a second conductive line formed on the encapsulant in FIG. 10.

FIG. 12 is a diagrammatic view illustrating an image sensor formed on the circuit board in FIG. 11.

FIG. 13 is a diagrammatic view illustrating the image sensor being connected to the circuit board.

FIG. 14 is a diagrammatic view illustrating a circuit board assembly according to an embodiment of the present disclosure.

FIG. 15 is a diagrammatic view illustrating an autofocus camera module according to an embodiment of the present disclosure.

FIG. 16 is a diagrammatic view illustrating a circuit board assembly according to another embodiment of the present disclosure.

FIG. 17 is a diagrammatic view illustrating an autofocus camera module according to yet another embodiment of the present disclosure.

FIG. 18 is a diagrammatic view illustrating an autofocus camera module according to yet another embodiment of the present disclosure.

FIG. 19 is a diagrammatic view illustrating an autofocus camera module according to yet another embodiment of the present disclosure.

FIG. 20 is a diagrammatic view illustrating an autofocus camera module according to yet another embodiment of the present disclosure.

FIG. 21 is a diagrammatic view illustrating an electronic device according to an embodiment of the present disclosure.

FIG. 22 is a flowchart illustrating a manufacturing method for an autofocus camera module according to an embodiment of the present disclosure.

### DETAILED DESCRIPTION

It will be appreciated that for simplicity and clarity of illustration, where appropriate, reference numerals have been repeated among the different figures to indicate corresponding or analogous members. In addition, numerous specific details are set forth in order to provide a thorough understanding of the embodiments described herein. However, it will be understood by those of ordinary skill in the art that the embodiments described herein can be practiced without these specific details. In other instances, methods, procedures, and members have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to;” it specifically indicates open-ended inclusion or membership in the so-described combination, group, series, and the like.

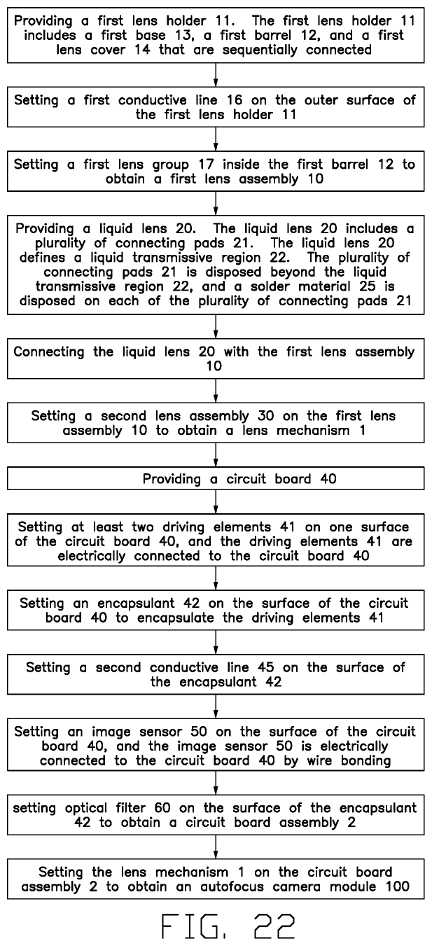

Referring to FIG. 22, a manufacturing method for the autofocus camera module 100 is provided according to an embodiment of the present disclosure. The method is provided by way of embodiments, as there are a variety of ways to carry out the method. Each block shown in FIG. 22 represents one or more processes, methods, or subroutines carried out in the method. Furthermore, the illustrated order of blocks can be changed. Additional blocks may be added or fewer blocks may be utilized, without departing from this disclosure. The method can begin at block S11.

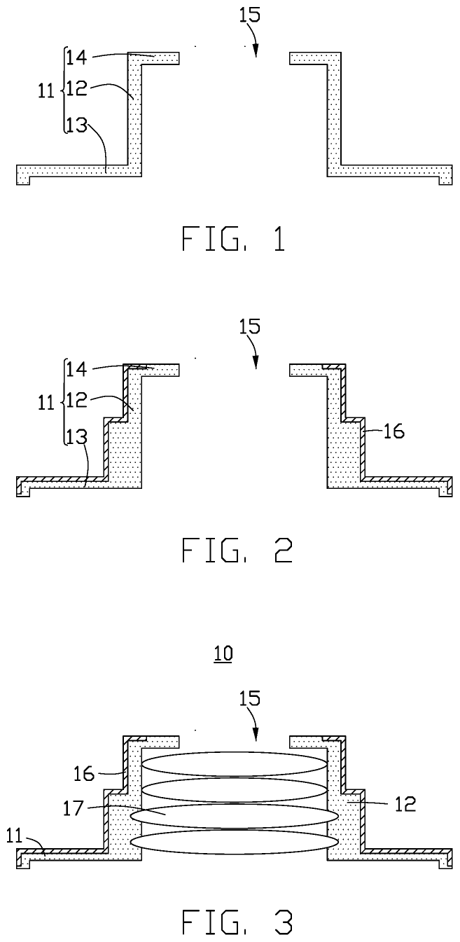

S11: referring to FIG. 1, a first lens holder 11 is provided. The first lens holder 11 includes a first base 13, a first barrel 12, and a first lens cover 14 that are sequentially connected. A first through hole 15 passes through the first lens holder 11.

S12: referring to FIG. 2, a first conductive line 16 is formed on the outer surface of the first lens holder 11.

In this embodiment, the first conductive line 16 is formed by a Laser Direct Structuring (LDS) technology. Specifically, conductive paths (not shown) are carved on the outer surface of the first lens holder 11 using laser rays. The conductive paths are then activated through a chemical plating to form the first conductive line 16.

In this embodiment, surface treatment may further be performed on the first conductive line 16 with gold to enhance the conductivity.

In this embodiment, the first lens holder 11 is made of plastic, and the first conductive line 16 extends from the first lens cover 14 to the first base 13.

S13: referring to FIG. 3, a first lens group 17 is formed inside the first barrel 12 to obtain a first lens assembly 10.

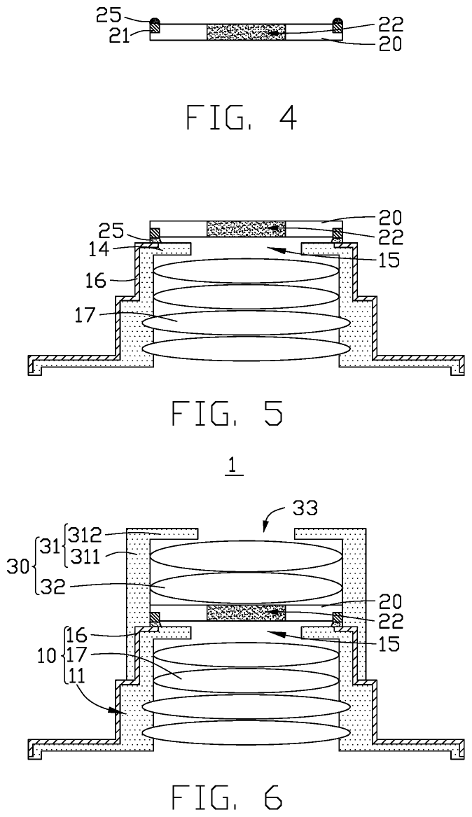

S14: referring to FIG. 4, a liquid lens 20 is provided. The liquid lens 20 includes a plurality of connecting pads 21. The liquid lens 20 defines a liquid transmissive region 22. The plurality of connecting pads 21 is disposed beyond the liquid transmissive region 22, and a solder material 25 is disposed on each of the plurality of connecting pads 21.

In this embodiment, at least four connecting pads 21 are disposed on the surface of the liquid lens 20. In this embodiment, the liquid lens 20 is rectangular, with the four connecting pads 21 located at its four corners. The transmissive region 22 is positioned at the center of the liquid lens 20. The solder material 25 may be gold balls or silver balls.

In this embodiment, the solder material 25 is gold balls free of solder resist, thereby avoiding contamination to the first lens assembly 17 during the subsequent bonding process using heat and ultrasonic waves.

S15: referring to FIG. 5, the liquid lens 20 is electrically connected to the first lens assembly 10.

In this embodiment, S15 is carried out by connecting the liquid lens 20 to the first lens cover 14 using the solder material 25, and electrically connecting the two connecting pads 21 to the first conductive line 16. The transmissive region 22 corresponds to the first through hole 15.

In this embodiment, a flip-chip technology is used to pick up the liquid lens 20, and the liquid lens 20 is bonded to the first lens cover 14 by heat and ultrasonic waves. The bonding area between the first lens cover 14 and the liquid lens 20 is protected with an adhesive (not shown).

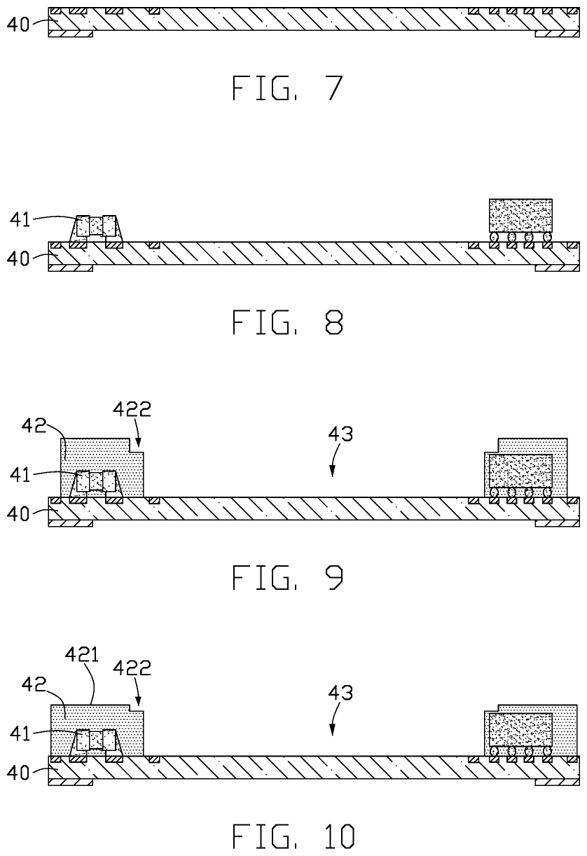

S16: referring to FIG. 6, a second lens assembly 30 is formed on the first lens assembly 10 to obtain a lens mechanism 1.

In this embodiment, the second lens assembly 30 includes a second lens holder 31 and a second lens assembly 32 housed inside the second lens holder 31. A second through hole 33 passes through the second lens holder 31.

S21: referring to FIG. 7, a circuit board 40 is provided.

S22: referring to FIG. 8, at least two driving elements 41 are formed on one surface of the circuit board 40, and the driving elements 41 are electrically connected to the circuit board 40. Each of the driving elements 41 may be a voltage controller capable of changing amplitudes, phases, and frequencies of the voltages.

In this embodiment, the driving elements 41 are disposed near an edge of the circuit board 40.

S23: referring to FIGS. 9 and 10, an encapsulant 42 is formed on the surface of the circuit board 40 to encapsulate the driving elements 41.

In this embodiment, a plastic (such as epoxy resin) can be set on the surface of the circuit board 40 through an injection molding. The plastic is solidified to form the encapsulant 42, which encapsulates the driving elements 41.

In this embodiment, the encapsulant 42 may further be ground to an appropriate size and to remove impurities on the surface of the encapsulant 42. Thus, the accuracy of subsequent processes can be ensured.

In this embodiment, the encapsulant 42 defines a first opening 43, and the surface of the circuit board 40 is partially exposed from the first opening 43. The encapsulant 42 includes a support surface 421 opposite the circuit board 40, and the support surface 421 is concave to form a step groove 422. The step groove 422 is around the center area of the circuit board 40 and is connected to the first opening 43.

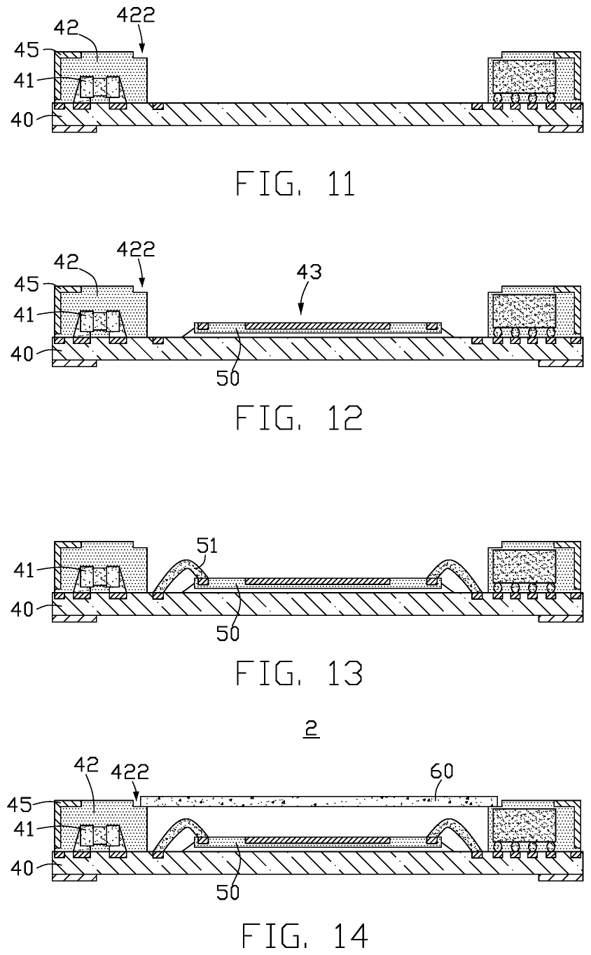

S24: referring to FIG. 11, a second conductive line 45 is formed on the surface of the encapsulant 42.

In this embodiment, the second conductive line 45 extends from the support surface 421 to the circuit board 40. The second conductive line 45 is electrically connected to the circuit board 40, and the second conductive line 45 avoids the step groove 422.

S25: referring to FIGS. 12 and 13, an image sensor 50 is formed on the surface of the circuit board 40, and the image sensor 50 is electrically connected to the circuit board 40 by wire bonding.

In this embodiment, the image sensor 50 is on the same surface of the circuit board 40 as the driving elements 41, and the image sensor 50 is exposed from the first opening 43. The image sensor 50 is electrically connected to the circuit board 40 by wires 51.

S26: referring to FIG. 14, an optical filter 60 is formed on the surface of the encapsulant 42 to obtain a circuit board assembly 2.

In this embodiment, the optical filter 60 is disposed into the step groove 422, and the optical filter 60 is opposite to the image sensor 50. Specifically, the optical filter 60 is fixed in the step groove 422 by an adhesive.

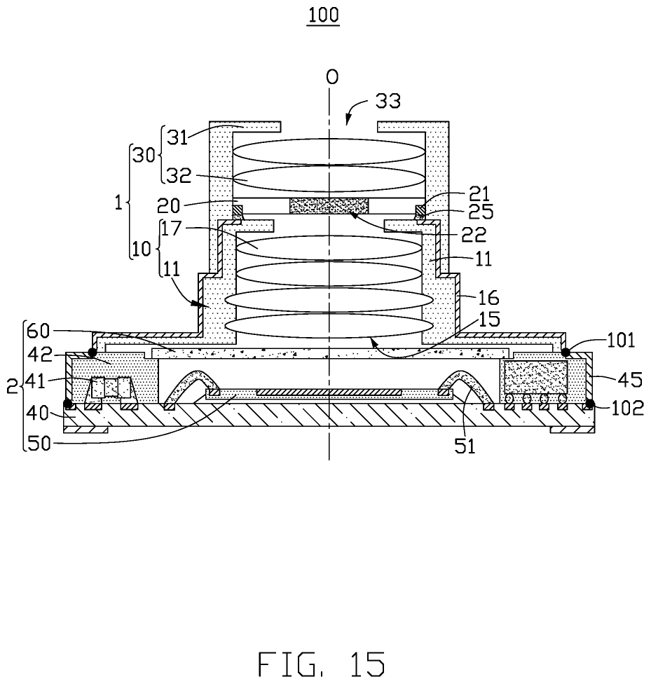

S30: referring to FIG. 15, the lens mechanism 1 is formed on the circuit board assembly 2 to obtain an autofocus camera module 100.

In this embodiment, referring to FIGS. 10 and 15, the first base 13 is disposed on the support surface 421 of the encapsulant 42, so that a portion of the optical filter 60 may be accommodated inside the first base 13. The liquid lens 20 is electrically connected to the second conductive line 45 through the first conductive line 16. The liquid lens 20 is electrically connected to the driving elements 41 through the first conductive line 16 and the second conductive line 45. The liquid lens 20 can be electrically driven by the driving elements 41 to achieve zooming.

The autofocus camera module 100 has an optical axis O. The center axis of the lens mechanism 1 and the circuit board assembly 2 are both coaxial with the optical axis O. The first through hole 15 and the second through hole 33 are coaxial with the optical axis O, so that light may pass through the autofocus camera module 100 along the optical axis O.

The method of the present disclosure applies the solder material 25 to the connecting pad 21 on the liquid lens 20, and uses the flip-chip bonding technology to electrically connect the liquid lens 20 to the first lens assembly 10. Furthermore, the first lens assembly 10 is electrically connected to the driving elements 41 by the first conductive line 16 on the first lens assembly 10 and the second conductive line 45 on the circuit board assembly 2, thereby achieving zooming. In comparison to the existing wire bonding method, the method of the present disclosure allows for rapid quality verification of the first lens assembly 10 and can avoid deviation or inclination of the liquid lens 20 during soldering. Furthermore, during the flip-chip bonding process, heat can be directly conducted from the heated liquid lens 20 to the bonding area between the first lens assembly 10 and the liquid lens 20, thereby eliminating the need for additional heating devices.

Referring to FIG. 15, an autofocus camera module 100 is also provided according to this embodiment. The autofocus camera module 100 can be obtained by the manufacturing method described above. The autofocus camera module 100 includes a circuit board assembly 2 and a lens mechanism 1 set on the circuit board assembly 2.

The lens mechanism 1 includes a first lens assembly 10, a liquid lens 20, and a second lens assembly 30. The first lens assembly 10 is configured onto the circuit board assembly 2. The liquid lens 20 and the second lens assembly 30 are configured onto one side of the first lens assembly 10 facing away from the circuit board assembly 2. The liquid lens 20 is positioned between the first lens assembly 10 and the second lens assembly 30. The first lens assembly 10 includes a first lens holder 11 and a first lens assembly 17 housed inside the first lens holder 11. The outer surface of the first lens holder 11 is provided with first conductive line 16. The surface of the liquid lens 20 includes a plurality of connecting pads 21, each of the plurality of connecting pads 21 has solder material 25. The plurality of connecting pads 21 is soldered to the first lens holder 11 by the solder material 25, and the liquid lens 20 is electrically connected to the first conductive line 16. The second lens assembly 30 includes a second lens holder 31 and a second lens assembly 32 housed inside the second lens holder 31. The second lens holder 31 is set on the first lens holder 11, and the liquid lens 20 is accommodated in the second lens holder 31.

The first lens holder 11 defines a first through hole 15, and the liquid lens 20 has a liquid transmissive region 22 positioned at the center of the first through hole 15. The second lens holder 31 defines a second through hole 33. The first through hole 15, the transmissive region 22, and the second through hole 33 correspond to each other.

The circuit board assembly 2 includes a circuit board 40, driving elements 41, an encapsulant 42, an image sensor 50, and an optical filter 60. The driving elements 41 and the image sensor 50 are arranged on a surface of the circuit board 40, and the driving elements 41 are electrically connected to the circuit board 40. The encapsulant 42 encapsulates the driving elements 41. The first lens holder 11 and the optical filter 60 are arranged on a surface of the encapsulant 42 facing the lens mechanism 1, and portion of the optical filter 60 is accommodated inside the first lens holder 11. The encapsulant 42 defines a first opening 43, the image sensor 50 is exposed from the first opening 43. The encapsulant 42 is provided with a second conductive line 45 on a surface of the encapsulant 42 away from the first opening 43, and the second conductive line 45 is electrically connected to the circuit board 40. The driving elements 41 can electrically drive the liquid lens 20 by the second conductive line 45 and the first conductive line 16 to achieve zooming.

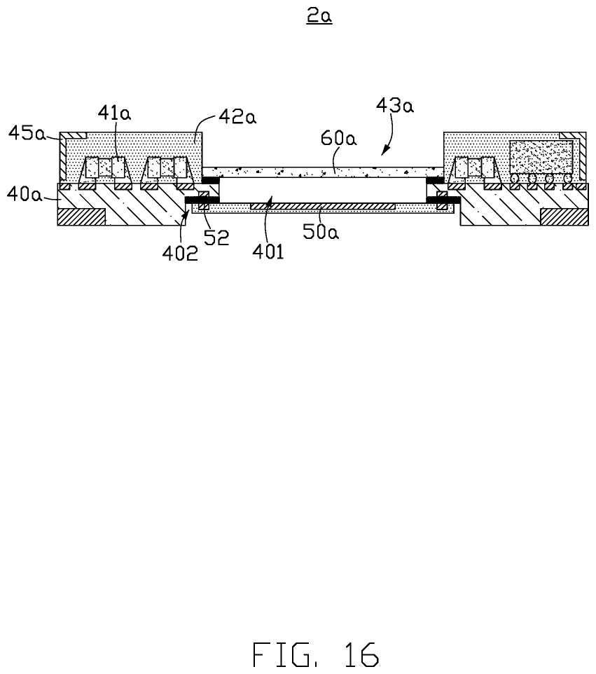

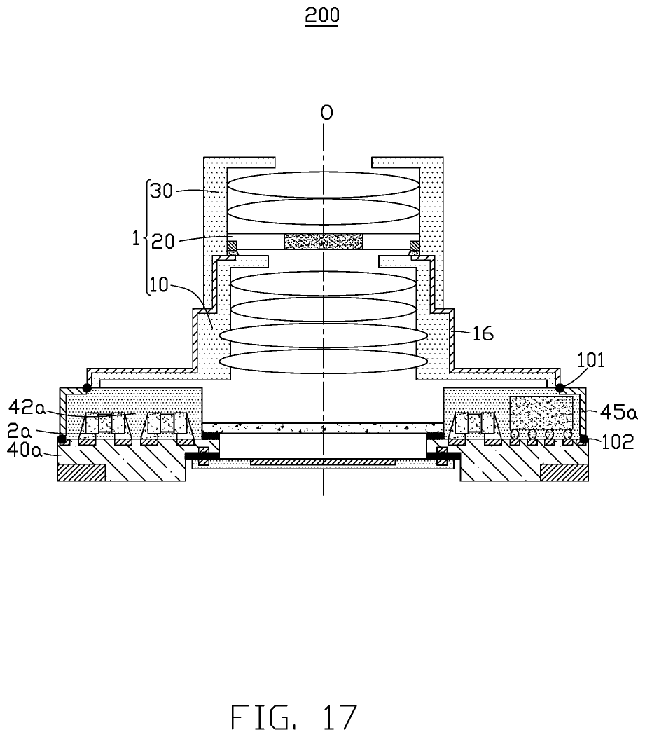

Referring to FIGS. 16 and 17, an autofocus camera module 200 is also provided according to another embodiment of the present disclosure, which differs from the autofocus camera module 100 in the structure of the circuit board assembly 2. The autofocus camera module 200 includes a circuit board assembly 2a and a lens mechanism 1 set on the circuit board assembly 2a. The circuit board assembly 2a includes a circuit board 40a, driving elements 41a, an encapsulant 42a, a second conductive line 45a, an image sensor 50a, and an optical filter 60a. The circuit board 40a defines a through hole 401. The driving elements 41a and the image sensor 50a are set on opposite surfaces of the circuit board 40a and are electrically connected to the circuit board 40a. The encapsulant 42a encapsulates the driving elements 41a. The optical filter 60a is set on the surface of the circuit board 40a and is positioned opposite the image sensor 50a through the through hole 401. The second conductive line 45a is set on the surface of the encapsulant 42a away from the through hole 401 and is electrically connected to the driving elements 41a.

In this embodiment, the circuit board 40a has a recessed groove 402 on the surface away from the lens mechanism 1, and the recessed groove 402 is connected to the through hole 401. The image sensor 50a is set inside the recessed groove 402. The encapsulant 42a has a first opening 43a connecting to the through hole 401, and the optical filter 60a and the image sensor 50a are exposed from the first opening 43a.

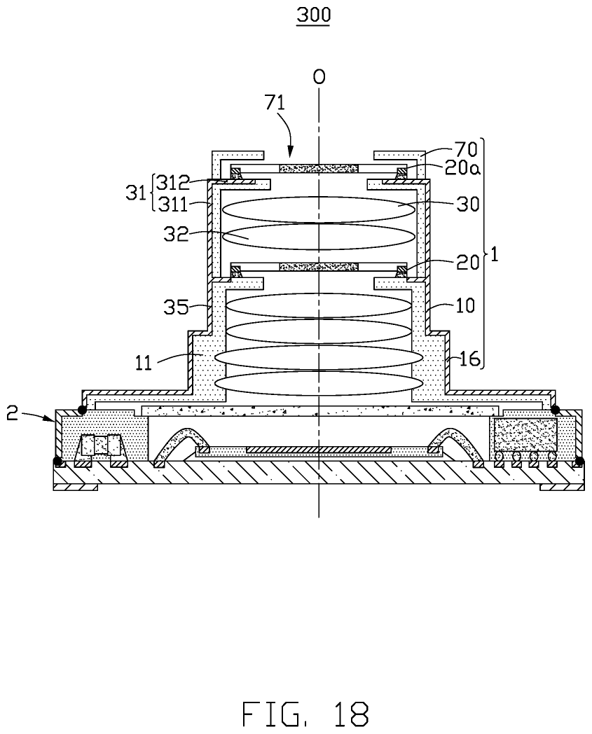

Referring to FIG. 18, an autofocus camera module 300 is also provided according to yet another embodiment of this application. The autofocus camera module 300 also includes a liquid lens 20a and a protective cover 70. The surface of the second lens holder 31 is provided with a third conductive line 35, which is electrically connected to the first conductive line 16. The liquid lens 20a is soldered to the second lens holder 31, away from the first lens holder 11, and the liquid lens 20a is electrically connected to the third conductive line 35. The protective cover 70 is set on the side of the second lens holder 31 away from the first lens holder 11 and covers the liquid lens 20a. The protective cover 70 defines a second opening 71, and part of the liquid lens 20a is exposed from the second opening 71 to allow light to pass through. The inclusion of the liquid lens 20a and the protective cover 70 further improves the auto-focusing performance of the autofocus camera module 300.

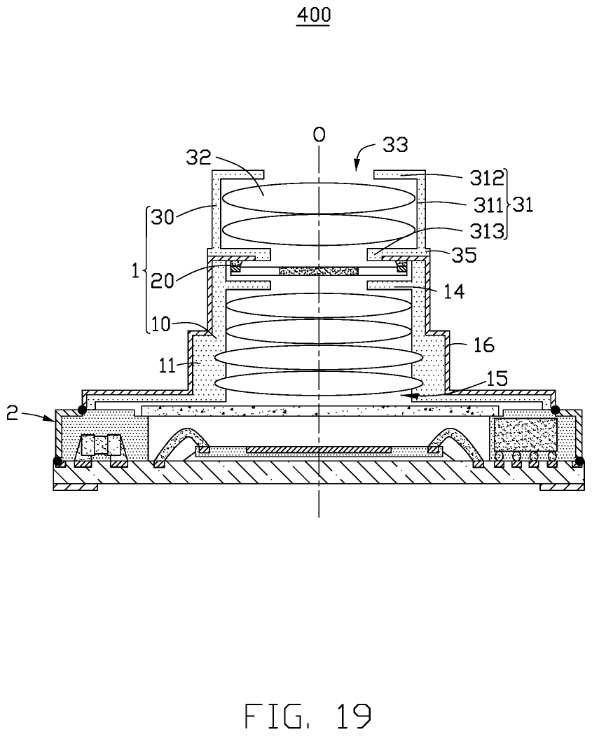

Referring to FIG. 19, an autofocus camera module 400 is also provided according to yet another embodiment of the present application. Different from the autofocus camera module 100, the second lens holder 31 also has a second base 313, which is set on the first lens holder 11. The surface of the second base 313 is provided with a third conductive line 35, which is electrically connected to the first conductive line 16. The liquid lens 20 is soldered to the second base 313 through a flip-chip bonding technology, facing the surface of the first lens holder 11.

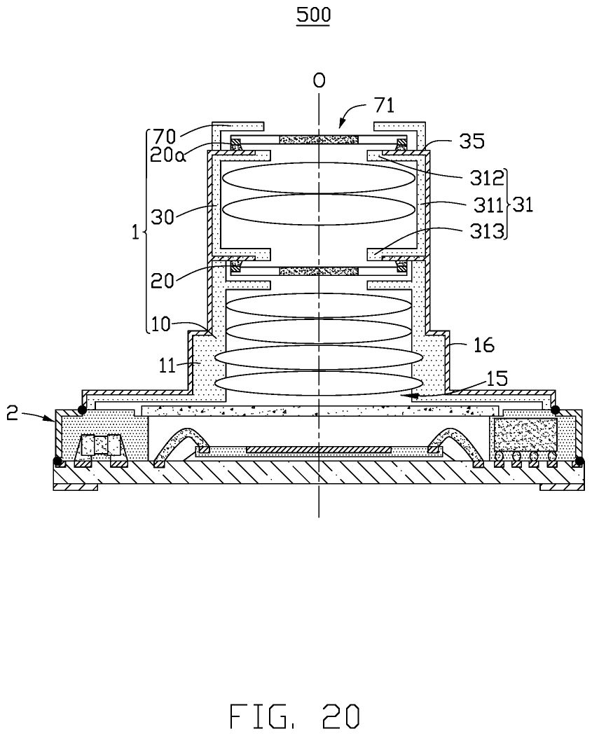

Referring to FIG. 20, an autofocus camera module 500 is also provided according to yet another embodiment of the present application. Different form the autofocus camera module 300, the second lens holder 31 also has a second base 313, which is set on the first lens holder 11. The surface of the second lens holder 31 is provided with a third conductive line 35, which is electrically connected to the first conductive line 16. The liquid lens 20 is soldered to the second base 313 through a flip-chip bonding technology, and facing the surface of the first lens holder 11.

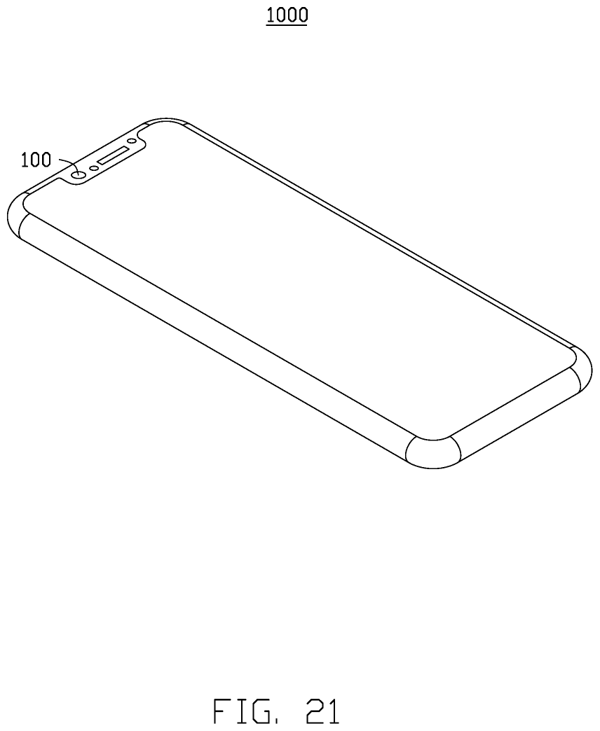

Referring to FIG. 21, an electronic device 1000 is provided according to this application, the electronic device 1000 includes any one of the autofocus camera modules 100 to 500. The electronic device 1000 can be a mobile phone, a wearable/handheld device, an aerial camera, etc. In this embodiment, the electronic device 1000 is a mobile phone.

Even though h information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present exemplary embodiments, to the full extent indicated by the plain meaning of the terms in which the appended claims are expressed.

What is claimed is:

1. A manufacturing method for an autofocus camera module, comprising:
providing a first lens assembly, a liquid lens, and a circuit board assembly, wherein the first lens assembly comprises a first lens holder and a first lens group received in the first lens holder, the liquid lens comprises a plurality of connecting pads, and the circuit board assembly comprises a plurality of driving elements;
forming a first conductive line on the first lens holder;
applying a solder material onto the plurality of connecting pads of the liquid lens;
soldering the plurality of connecting pads of the liquid lens to one side of the first lens holder through the solder material, thereby causing the plurality of connecting pads to be electrically connected to one end of the first conductive line; and
mounting the circuit board assembly to another side of the first lens assembly, thereby causing another end of the first conductive line to be electrically connected to the plurality of driving elements.

2. The method according to claim 1, wherein the first lens holder is provided with a first base, a first lens barrel, and a first lens cover sequentially connected to each other, and forming the first conductive line on the first lens holder further comprises:
forming the first conductive line on the first lens holder by laser direct forming technology, the first conductive line extends from the first lens cover to the first base, and
soldering the plurality of connecting pads of the liquid lens to the one side of the first lens holder through the solder material further comprises:
soldering the plurality of connecting pads of the liquid lens to the first lens cover through the solder material.

3. The method according to claim 1, wherein a method for manufacturing the circuit board assembly comprises:
setting the plurality of driving elements on a surface of a circuit board;
setting an encapsulant on the surface of the circuit board to encapsulate the plurality of driving elements;
forming a second conductive line on the encapsulant, thereby causing the second conductive line to be electrically connected to the plurality of driving elements;
setting an image sensor on the surface of the circuit board containing the plurality of driving elements; and
setting an optical filter on a surface of the encapsulant away from the circuit board, thereby causing the optical filter to correspond to the image sensor.

4. The method of claim 3, wherein mounting the circuit board assembly to the another side of the first lens assembly further comprises:
electrically connecting the first conductive line to the second conductive line.

5. The method according to claim 1, wherein after soldering the plurality of connecting pads of the liquid lens to the one side of the first lens holder, the method further comprises:
setting a second lens assembly on a side of the first lens assembly containing the first lens holder, wherein the second lens assembly comprises a second lens holder and a second lens assembly received in the second lens holder; and
accommodating the liquid lens inside the second lens holder.

6. The method according to claim 5, further comprising:
forming a third conductive line on the second lens holder, thereby causing the third conductive line to be electrically connected to the first conductive line; and
soldering another liquid lens on a side of the second lens holder away from the first lens holder, thereby causing the another liquid lens to be electrically connected to the third conductive line.

7. An autofocus camera module comprising:
a circuit board assembly comprising a plurality of driving elements; and
a lens mechanism disposed on the circuit board assembly, the lens mechanism comprising:
a first lens assembly;
a second lens assembly; and
a liquid lens disposed between the first lens assembly and the second lens assembly,
wherein the first lens assembly comprises a first lens holder, a first lens group received in the first lens holder, and a first conductive line disposed on the first lens holder, the first lens holder is connected to one side of the circuit board assembly, and
the liquid lens comprises a plurality of connecting pads and a solder material located on the plurality of connecting pads, the plurality of connecting pads of the liquid lens is soldered to the first lens holder through the solder material, the first conductive line electrically connects the plurality of connecting pads and the plurality of driving elements.

8. The autofocus camera module of claim 7, wherein the circuit board assembly further comprises a circuit board, a second conductive line, and an encapsulant, the plurality of driving elements is arranged on the circuit board, the encapsulant encapsulates the plurality of driving elements, and the second conductive line connects the first conductive line and the circuit board.

9. The autofocus camera module of claim 8, wherein the circuit board assembly further comprises an image sensor, the encapsulant defines a first opening, a portion of the circuit board is exposed from the first opening, the image sensor is disposed in the first opening and connected to the circuit board.

10. The autofocus camera module of claim 9, wherein the circuit board assembly further comprises an optical filter, the optical filter is arranged on a surface of the encapsulant, the optical filter covers the first opening and faces the image sensor, and a portion of the optical filter is accommodated in the first lens holder.

11. The autofocus camera module of claim 7, wherein the second lens assembly comprises a second lens holder and a second lens group received in the second lens holder, the second lens holder is disposed on a side of the first lens holder away from the circuit board assembly, and the liquid lens is accommodated in the second lens holder.

12. The autofocus camera module of claim 7, further comprising another liquid lens, wherein the second lens assembly further comprises a third conductive line, one end the third conductive line is connected to the first conductive line, the another liquid lens is disposed on a surface of the second lens holder away from the first circuit board assembly, and another end of the third conductive line is connected to the another liquid lens.

13. The autofocus camera module of claim 12, further comprising a protective cover, wherein the protective cover is disposed on a surface of the second lens holder away from the first circuit board assembly, the protective cover defines a second opening, and a portion of the another liquid lens is exposed from the second opening.

14. An electronic device comprising an autofocus camera module, the autofocus camera module comprising:
a circuit board assembly connected with a plurality of driving elements; and
a lens mechanism disposed on the circuit board assembly, the lens mechanism comprising:
a first lens assembly;
a second lens assembly; and
a liquid lens disposed between the first lens assembly and the second lens assembly,
wherein the first lens assembly comprises a first lens holder, a first lens group received inside the first lens holder, and a first conductive line disposed on a surface of the first lens holder, the first lens holder is connected to one side of the circuit board assembly, and
the liquid lens comprises a plurality of connecting pads, and each of the plurality of connecting pads is disposed with solder material, the plurality of connecting pads of the liquid lens is soldered to the first lens holder through the solder material, the first conductive line connects between the plurality of connecting pads and the plurality of driving elements.

15. The electronic device of claim 14, wherein the circuit board assembly further comprises a circuit board, a second conductive line, and an encapsulant, the plurality of driving elements is arranged on the circuit board, the encapsulant encapsulates the plurality of driving elements, and the second conductive line connects the first conductive line and the circuit board.

16. The electronic device of claim 15, wherein the circuit board assembly further comprises an image sensor, the encapsulant defines a first opening, a portion of the circuit board is exposed from the first opening, the image sensor is disposed in the first opening and connected to the circuit board.

17. The electronic device of claim 16, wherein the circuit board assembly further comprises an optical filter, the optical filter is arranged on a surface of the encapsulant, the optical filter covers the first opening and faces the image sensor, a portion of the optical filter is accommodated in the first lens holder.

18. The electronic device of claim 14, wherein the second lens assembly comprises a second lens holder and a second lens group received in the second lens holder, the second lens holder is disposed on a side of the first lens holder away from the circuit board assembly, and the liquid lens is accommodated in the second lens holder.

19. The electronic device of claim 14, further comprising another liquid lens, wherein the second lens assembly further comprises a third conductive line, one end the third conductive line is connected to the first conductive line, the another liquid lens is disposed on a surface of the second lens holder away from the first circuit board assembly, and another end of the third conductive line is connected to the another liquid lens.

20. The electronic device of claim 19, further comprising a protective cover, the protective cover is disposed on a surface of the second lens holder away from the first circuit board assembly, the protective cover defines a second opening, a portion of another liquid lens is exposed from the second opening.
